(19) United States
(12) Patent Application Publication
(10) Pub. No.: US 2011/0211294 A1
(43) Pub. Date: Sep. 1, 2011

(54) METHOD OF MANUFACTURING SOLID ELECTROLYTIC CAPACITOR AND SOLID ELECTROLYTIC CAPACITOR

(75) Inventor: Masahiro Ueda, Osaka (JP)

(73) Assignee: SANYO ELECTRIC CO., LTD., Osaka (JP)

(21) Appl. No.: 13/034,961

(22) Filed: Feb. 25, 2011

(30) Foreign Application Priority Data
Feb. 26, 2010 (JP) 2010-042795

(51) Int. Cl. H01G 9/025; H01G 9/15; H01G 9/00

(52) U.S. Cl. 361/525; 29/25.03

(57) ABSTRACT

A method of manufacturing a solid electrolytic capacitor includes the steps of forming a dielectric film on a surface of an anode element, forming a first conductive polymer layer on the dielectric film, impregnating the anode element having the first conductive polymer layer formed with an ion liquid, and forming a second conductive polymer layer on the first conductive polymer layer after impregnation with the ion liquid.

This nonprovisional application is based on Japanese Patent Application No. 2010-042795 filed with the Japan Patent Office on Feb. 26, 2010, the entire contents of which are hereby incorporated by reference.

### BACKGROUND OF THE INVENTION

1. Field of the Invention

The present invention relates to a method of manufacturing a solid electrolytic capacitor and a solid electrolytic capacitor, and particularly to a method of manufacturing a solid electrolytic capacitor by using an ion liquid and a solid electrolytic capacitor including an ion liquid.

2. Description of the Related Art

A solid electrolytic capacitor has conventionally widely been known as a capacitor suitable for reduction in size. A solid electrolytic capacitor has an anode element having a dielectric film formed on a surface thereof and further has a solid electrolyte between the anode element and a cathode layer.

An anode element obtained by etching a metal plate or a metal foil of a valve metal, an anode element obtained by sintering molded valve metal powders, and the like are available as an anode element, and a dielectric film can be formed by subjecting a surface of such an anode element to electrolytic oxidation. The dielectric film thus formed is extremely dense, high in durability, and very thin. Therefore, as compared with other capacitors such as a paper capacitor and a film capacitor, the solid electrolytic capacitor can be reduced in size without lowering capacitance.

Meanwhile, manganese dioxide, a conductive polymer and the like have been known as a material for a solid electrolyte. In particular, electric conductivity of a solid electrolyte composed of a conductive polymer such as polypyrrole, polyaniline or polythiophene is high and hence an equivalent series resistance (hereinafter referred to as “ESR”) of the solid electrolytic capacitor can be lowered.

A method making use of chemical polymerization and a method making use of electrolytic polymerization are available as a method of forming a conductive polymer layer. In the method making use of chemical polymerization, for example, a conductive polymer layer can be formed on a dielectric film by attaching an oxidizing agent and a monomer to the dielectric film and subjecting the monomer to oxidation polymerization on the dielectric film. Meanwhile, in the method making use of electrolytic polymerization, for example, a conductive polymer layer can be formed on a dielectric film by immersing an anode element having the dielectric film formed in an electrolyte and subjecting the monomer to oxidation polymerization utilizing oxidation reaction that occurs at an anode.

A conductive polymer layer can lower ESR of the solid electrolytic capacitor, whereas the conductive polymer layer itself does not have ion conductivity. Therefore, the conductive polymer layer cannot have capability of repairing a damaged dielectric film, that is, an anodic oxidation function. Thus, a solid electrolytic capacitor having a conductive polymer layer is disadvantageously lower in withstand voltage performance than other solid electrolytic capacitors.

A technique making use of an ion liquid has been expected as a technique for solving the problem above. The ion liquid is a salt molten and kept in a liquid state in an environment at room temperature and it has such characteristics as non-volatility and high ion conductivity. Therefore, presence of an ion liquid in a conductive polymer layer can allow a damaged portion of the dielectric film to be repaired and the ion liquid is considered to be able to enhance withstand voltage performance of a solid electrolytic capacitor.

For example, Japanese Patent Laying-Open Nos. 2006-24708, 2008-16835 and 2008-218920 describe a technique relating to a solid electrolytic capacitor having a conductive polymer layer containing an ion liquid, as a technique using such an ion liquid. Specifically, according to the description, a solid electrolytic capacitor higher in withstand voltage performance than a conventional solid electrolytic capacitor is obtained by forming a conductive polymer layer after an ion liquid is attached to a dielectric film.

A high-performance solid electrolytic capacitor, however, has also currently increasingly been demanded, and further technical development has been demanded.

### SUMMARY OF THE INVENTION

In view of the circumstances above, an object of the present invention is to provide a method of manufacturing a high-performance solid electrolytic capacitor achieving high withstand voltage performance and such a solid electrolytic capacitor.

As a result of the present inventors' dedicated studies for achieving the object above, the present inventors found that a high-performance solid electrolytic capacitor can be manufactured by impregnating a conductive polymer layer with an ion liquid after the conductive polymer layer was formed.

Namely, a first aspect of the present invention is directed to a method of manufacturing a solid electrolytic capacitor including the steps of forming a dielectric film on a surface of an anode element, forming a first conductive polymer layer on the dielectric film, impregnating the anode element having the first conductive polymer layer formed with an ion liquid, and forming a second conductive polymer layer on the first conductive polymer layer after impregnation with the ion liquid.

In addition, a second aspect of the present invention is directed to a solid electrolytic capacitor including a capacitor element which has an anode element having a dielectric film formed on a surface thereof and a conductive polymer layer formed on the anode element, the conductive polymer layer having a first conductive polymer layer formed on the dielectric film and a second conductive polymer layer formed on the first conductive polymer layer, an ion liquid being present in the first conductive polymer layer, and the second conductive polymer layer having a structure denser than the first conductive polymer layer.

According to the present invention, a method of manufacturing a high-performance solid electrolytic capacitor achieving high withstand voltage performance and the solid electrolytic capacitor can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a flowchart of one preferred example of a method of manufacturing a solid electrolytic capacitor according to the present embodiment.

FIGS. 2A to 2F are schematic cross-sectional views illustrating the manufacturing method in line with the flowchart in FIG. 1.

FIG. 3 is a diagram schematically showing one example of a construction of an electrolytic polymerization apparatus.

FIG. 4 is a cross-sectional view schematically showing one preferred example of a structure of a solid electrolytic capacitor according to the present embodiment.

### DESCRIPTION OF THE PREFERRED EMBODIMENTS

An embodiment of the present invention will be described hereinafter with reference to the drawings. In the drawings below, the same or corresponding elements have the same reference characters allotted and description thereof will not be repeated. It is noted that dimensional relation such as length, size, and width in the drawings is modified as appropriate for the sake of clarification and brevity of the drawings, and does not represent an actual dimension.

<Method of Manufacturing Solid Electrolytic Capacitor>

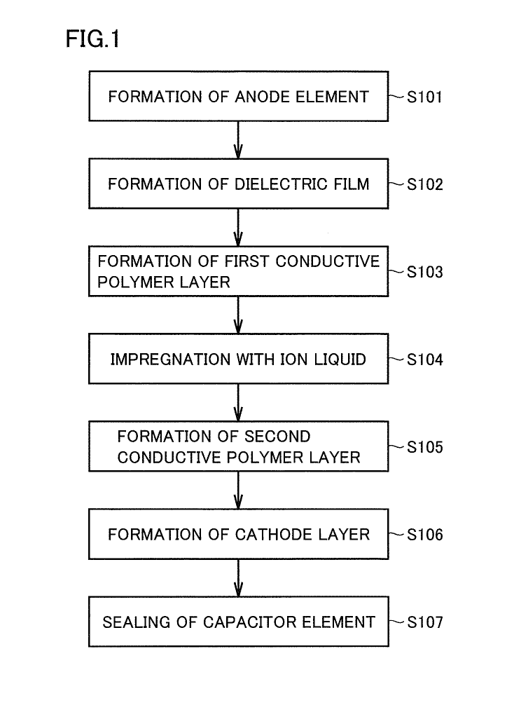

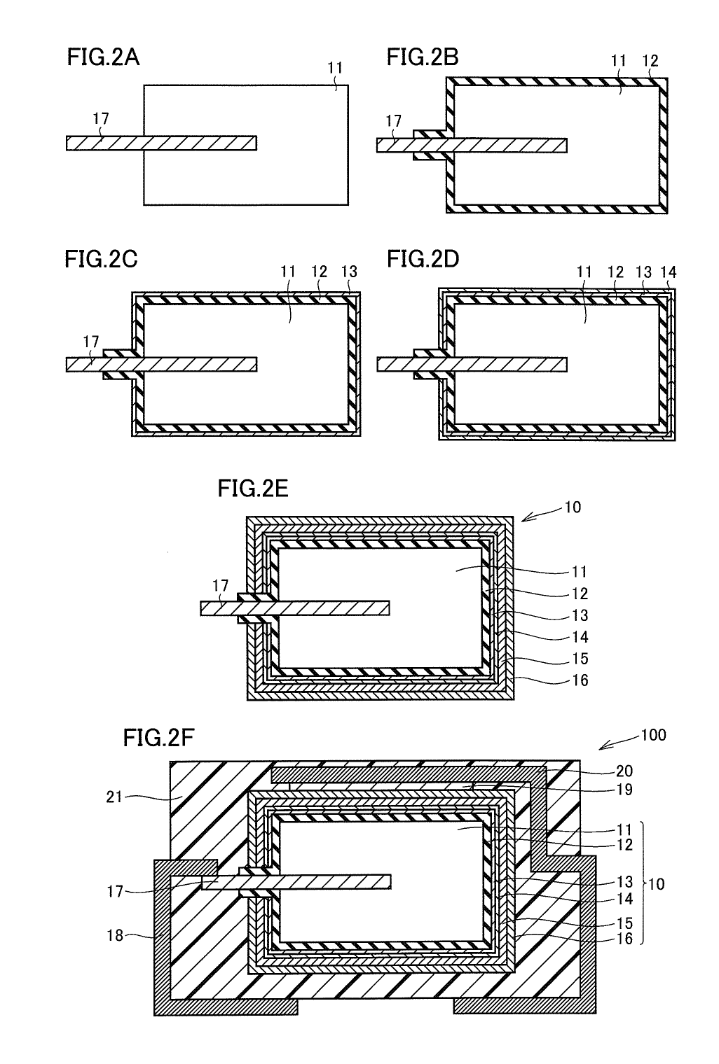

One preferred example of a method of manufacturing a solid electrolytic capacitor according to the present embodiment will be described hereinafter. Here, a method of manufacturing a solid electrolytic capacitor having an anode element made of a sintered object will be described with reference to FIGS. 1 and 2A to 2F.

1. Formation of Anode Element (Anode Element Formation Step)

Initially, an anode element 11 is formed in step S101 in FIG. 1. Specifically, valve metal powders are prepared and the powders are molded in a desired shape while one end side in a longitudinal direction of a rod-shaped anode lead 17 is buried in the metal powders. Then, by sintering these molded powders, anode element 11 having a porous structure as shown in FIG. 2A, in which one end of anode lead 17 is buried, is fabricated. Tantalum, niobium, titanium, aluminum, or the like can be used as a valve metal. Anode lead 17 is made of a metal, and a valve metal can suitably be used.

2. Formation of Dielectric Film (Dielectric Film Formation Step)

Then, a dielectric film 12 is formed on the surface of anode element 11 in step S102 in FIG. 1. Through the present step, dielectric film 12 is formed on the surface of anode element 11 as shown in FIG. 2B.

Dielectric film 12 is formed by subjecting a valve metal to chemical conversion treatment. A method of immersing anode element 11 in a chemical conversion solution such as a phosphoric acid aqueous solution, a nitric acid aqueous solution or the like and then applying a voltage is available as a chemical conversion method. For example, when tantalum (Ta) is used as the valve metal, dielectric film 12 is composed of Ta₂O₅, and when aluminum (Al) is used as the valve metal, dielectric film 12 is composed of Al₂O₃.

3. Formation of First Conductive Polymer Layer (First Conductive Polymer Layer Formation Step)

Then, a first conductive polymer layer 13 is formed on dielectric film 12 in step S103 in FIG. 1. Through the present step, first conductive polymer layer 13 is formed on dielectric film 12 as shown in FIG. 2C.

First conductive polymer layer 13 is preferably formed through chemical polymerization. First conductive polymer layer 13 formed through chemical polymerization is in a shape distributed on dielectric film 12. In other words, first conductive polymer layer 13 has a structure having a plurality of conductive polymer portions and a large number of opening portions between the conductive polymer portions. Therefore, when first conductive polymer layer 13 is formed through chemical polymerization, dielectric film 12 has a portion covered with first conductive polymer layer 13 and a portion exposed to the outside without being covered with first conductive polymer layer 13.

As first conductive polymer layer 13 has the structure as above, in an ion liquid impregnation step which will be described later, first conductive polymer layer 13 can not only be impregnated with an ion liquid but also remain in a gap between distributed first conductive polymer layers 13, and further, the ion liquid can be attached to the surface of dielectric film 12 exposed through first conductive polymer layer 13. Therefore, anode element 11 having first conductive polymer layer 13 present in a distributed manner on dielectric film 12 formed can hold a larger amount of ion liquid, and in addition, frequency of contact between dielectric film 12 and the ion liquid can be increased and thus a contact area can be made larger.

As a method of forming first conductive polymer layer 13 through chemical polymerization, for example, a method of exposing anode element 11 having dielectric film 12 to which an oxidizing agent and a dopant have been attached, to a gas containing a monomer for a polymer is available. As a method of attaching an oxidizing agent and a dopant to anode element 11, for example, a method of immersing anode element 11 in a solution containing the oxidizing agent and the dopant is available. Alternatively, anode element 11 may be immersed in each of a solution containing the oxidizing agent and a solution containing the dopant. Alternatively, each solution may be applied to anode element 11. According to this method, first conductive polymer layer 13 having a shape distributed on dielectric film 12 can readily be formed.

The method above represents vapor phase polymerization of chemical polymerization, however, first conductive polymer layer 13 may be formed through liquid phase polymerization instead of vapor phase polymerization. For example, a method of subjecting a monomer to oxidation polymerization on dielectric film 12 by immersing anode element 11 having dielectric film 12 formed in a solution containing a monomer for a polymer forming first conductive polymer layer 13, an oxidizing agent and a dopant is available. The monomer, the oxidizing agent and the dopant do not have to be contained in a single solution, but they are contained in separate solutions, respectively. Alternatively, a solution containing any two components of the monomer, the oxidizing agent and the dopant and a solution containing remaining one component may be employed. In a case of oxidation polymerization using two or more solutions, the order of immersion in each solution is not particularly restricted.

In the case of liquid phase polymerization, since a rate of polymerization of a monomer is higher than in the case of vapor phase polymerization, conductive polymers forming first conductive polymer layer 13 on dielectric film 12 are deposited faster. Therefore, if liquid phase polymerization is performed for a long period of time, an amount of deposited conductive polymers increases and first conductive polymer layer 13 is deposited on dielectric film 12 to a large thickness. Consequently, a case where first conductive polymer layer 13 is in such a shape as covering the entire surface of the dielectric film, instead of a shape distributed on dielectric film 12, is possible. Therefore, in forming first conductive polymer layer 13 through liquid phase polymerization, a rate of polymerization of a monomer is preferably controlled.

A polymer having at least one of an aliphatic compound, an aromatic compound, a heterocyclic compound, and a heteroatom-containing compound can be employed as the monomer. Among these, thiophene and derivatives thereof, pyrrole and derivatives thereof, aniline and derivatives thereof, and furan and derivatives thereof are preferred, and in particular pyrrole and derivatives thereof can suitably be employed. By employing these, first conductive polymer layer 13 constituted of a polythiophene skeleton, a polypyrrole skeleton, a polyaniline skeleton, and a polyfuran skeleton can be formed.

A known oxidizing agent can be employed as the oxidizing agent, and for example, hydrogen peroxide, permanganic acid, hypochlorous acid, chromic acid, and the like can be exemplified. In addition, a known dopant can be employed as the dopant, and for example, an acid or a salt of a sulfonic acid compound such as alkyl sulfonic acid, aromatic sulfonic acid, and polycyclic aromatic sulfonic acid, as well as sulfuric acid, nitric acid, and the like can be exemplified. Alternatively, a known oxidizing agent-dopant can be employed instead of the oxidizing agent and the dopant.

4. Cleaning of Anode Element (Cleaning Step)

In the present embodiment, in the cleaning step, after first conductive polymer layer 13 is formed, anode element 11 having first conductive polymer layer 13 formed may be cleaned. In general, when a conductive polymer layer is formed through chemical polymerization, in many cases, an unnecessary oxidizing agent or an unreacted monomer remains on the anode element. Such a residue will become a factor for increase in ESR of a solid electrolytic capacitor. Therefore, by cleaning anode element 11 after formation of first conductive polymer layer 13 on dielectric film 12, such residue as an unnecessary oxidizing agent or an unreacted monomer on dielectric film 12 on the surface and in a pore of anode element 11 as well as on first conductive polymer layer 13 can be removed and hence increase in ESR can be suppressed.

As a method of cleaning anode element 11, for example, a method of immersing anode element 11 having first conductive polymer layer 13 formed in water and then taking it out of water is available. Water is preferably pure water or ultrapure water, and immersion and taking out may be repeated several times. Alternatively, the residue may be removed by pouring water over anode element 11 having first conductive polymer layer 13 formed. In a case where such a cleaning step is provided, anode element 11 is preferably dried before performing the ion liquid impregnation step which is the next step.

Here, if the cleaning step is performed after the ion liquid impregnation step which will be described later, the ion liquid for impregnation will flow away, which is not preferred. By performing the cleaning step before the ion liquid impregnation step, the ion liquid can be prevented from flowing away through cleaning and a high function to repair a damage in dielectric film 12 achieved by the ion liquid can be ensured.

5. Impregnation with Ion Liquid (Ion Liquid Impregnation Step)

Then, in step S104 in FIG. 1, anode element 11 having first conductive polymer layer 13 formed is impregnated with the ion liquid. By impregnating anode element 11 with the ion liquid, first conductive polymer layer 13 on dielectric film 12 is impregnated with the ion liquid, the ion liquid remains in a gap between distributed first conductive polymer layers 13, and further, the ion liquid is attached to the surface of dielectric film 12 exposed through first conductive polymer layer 13.

As a method of impregnating anode element 11 having first conductive polymer layer 13 formed with the ion liquid, for example, a method of immersing anode element 11 having first conductive polymer layer 13 formed in the ion liquid is available. A time period for immersion in this case is preferably not shorter than 5 minutes. By setting the time period for immersion to 5 minutes or longer, the ion liquid can penetrate into a deep pore in anode element 11 and thus first conductive polymer layer 13 present there can be impregnated with the ion liquid, and further the ion liquid can be attached onto dielectric film 12 present there. From a point of view of manufacturing efficiency, the time period is preferably not longer than 60 minutes. If the ion liquid has high viscosity and it is less likely to penetrate deep into a pore in anode element 11, for example by performing the present step in a reduced-pressure environment, the inside of the pore can readily be impregnated with the ion liquid.

As a cation component forming the ion liquid suitably used in the present invention, for example, ammonium ion and derivatives thereof, imidazolium ion and derivatives thereof, pyrrolidinium ion and derivatives thereof, phosphonium ion and derivatives thereof, and sulfonium ion and derivatives thereof can be exemplified. In particular, ammonium ion and derivatives thereof have a large potential window and they are chemically stable, and therefore they are more suitably employed.

As an anion component, for example, bis(trifluoromethanesulfonyl)imide ion ((CF₃SO₂)₂N⁻), trifluoromethanesulfonic acid ion (CF₃SO₃⁻), trifluoromethanesulfonyl ion (CF₃SO₂⁻), nitrate ion (NO₃⁻), acetic acid ion (CH₃CO₂⁻), tetrafluoroboric acid ion (BF₄⁻), hexafluorophosphoric acid ion (PF₆⁻), trifluoromethanecarboxylate ion (CF₃CO₂⁻), and the like can be exemplified. Among these, bis(trifluoromethanesulfonyl)imide ion and trifluoromethanesulfonic acid ion are preferred, and in particular bis(trifluoromethanesulfonyl)imide ion can suitably be employed.

Among the ion liquids in which the cation component and the anion component above are combined, in particular, any ion liquid of methyltri-n-octylammonium bis(trifluoromethanesulfonyl)imide, 1-butyl-2,3-dimethylimidazolium bis(trifluoromethanesulfonyl)imide, 1-butyl-3-methylimidazolium bis(trifluoromethanesulfonyl)imide, 1-ethyl-2,3-dimethylimidazolium bis(trifluoromethanesulfonyl)imide, 1-butyl-1-methylpyrrolidinium bis(trifluoromethanesulfonyl)imide, 1-methyl-1-propylpyrrolidinium bis(trifluoromethanesulfonyl)imide, cyclohexyltrimethylammonium bis(trifluoromethanesulfonyl)imide, tributyl(2-methoxyethyl)phosphonium bis(trifluoromethanesulfonyl)imide, tributylmethylammonium bis(trifluoromethanesulfonyl)imide, tributylmethylphosphonium bis(trifluoromethanesulfonyl)imide, and triethylsulfonium bis(trifluoromethanesulfonyl)imide is preferably employed. In particular, methyltri-n-octylammonium bis(trifluoromethanesulfonyl)imide expressed in a chemical formula (1) below can suitably be employed.

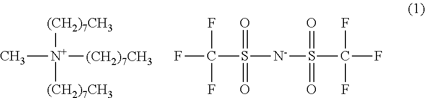

In addition, in the present step, instead of the ion liquid as it is, a solution containing the ion liquid may be employed. A solvent of the solution containing the ion liquid is preferably a solvent capable of dissolving 1% or more ion liquid and further preferably 10% or more ion liquid therein. For example, water, a glycol-based solvent, a glycol-ether-based solvent, an ether-based solvent, an alcohol-based solvent, a triglyceride-based solvent, a ketone-based solvent, an ester-based solvent, an amide-based solvent, a nitrile-based solvent, a sulfoxide-based solvent, and a sulfone-based solvent can be employed.

Specifically, for example, ethylene glycol, propylene glycol, butylene glycol, triethylene glycol, hexylene glycol, polyethylene glycol, ethoxydiglycol, and dipropylene glycol can be exemplified as the glycol-based solvent. For example, methyl glycol ether, ethyl glycol ether, and isopropyl glycol ether can be exemplified as the glycol-ether-based solvent. Diethyl ether and tetrahydrofuran can be exemplified as the ether-based solvent. Methanol, ethanol, n-propanol, isopropanol, and butanol can be exemplified as the alcohol-based solvent. Ethyl acetate, butyl acetate, diethylene glycol ether acetate, methoxy propyl acetate, and propylene carbonate can be exemplified as the ester-based solvent. Dimethylformamide, dimethylacetamide, dimethylcaprylamide, dimethylcapramide, and N-alkyl pyrrolidone can be exemplified as the amide-based solvent. Acetonitrile, propionitrile, butyronitrile, and benzonitrile can be exemplified as the nitrile-based solvent. Dimethyl sulfoxide and sulfolane can be exemplified as the sulfoxide-based solvent and the sulfone-based solvent, respectively. In particular, ethylene glycol, isopropanol and propylene carbonate can suitably be employed.

When the ion liquid is dissolved in the solvent above and the solution is used for impregnation of anode element 11 having first conductive polymer layer 13 formed with the ion liquid, not only the ion liquid but also the solvent are present on anode element 11. If the solvent is highly volatile, the solvent can be removed by leaving anode element 11 after immersion in an environment at room temperature. If the solvent has a high boiling point, the solvent can be removed by leaving anode element 11 in an environment at a temperature not lower than a boiling point of the solvent. A time period required for leaving here is preferably not shorter than 5 minutes in order to reliably remove the solvent, and from a point of view of manufacturing efficiency, the time period is preferably not longer than 60 minutes.

Presence/absence and distribution of the ion liquid in anode element 11 can be known, for example, by utilizing nuclear magnetic resonance spectroscopy. Specifically, a sample of anode element 11 impregnated with the ion liquid at each position, for example, a part of first conductive polymer layer 13, is taken as a sample and an appropriate solvent is used to extract the ion liquid in each sample into the solvent. Then, presence/absence and distribution of the ion liquid in first conductive polymer layer 13 can be known by subjecting this solvent to a nuclear magnetic resonance spectrometer and detecting a spectrum specific to a molecule forming the ion liquid. In a case where an anion component in the ion liquid is bis(trifluoromethanesulfonyl)imide ion, presence/absence and distribution of the ion liquid in anode element 11 can be known, for example, by detecting a spectrum derived from fluorine.

6. Formation of Second Conductive Polymer Layer (Second Conductive Polymer Layer Formation Step)

Then, a second conductive polymer layer 14 is formed on first conductive polymer layer 13 in step S105 in FIG. 1. Through the present step, as shown in FIG. 2D, second conductive polymer layer 14 is formed on first conductive polymer layer 13 impregnated with the ion liquid.

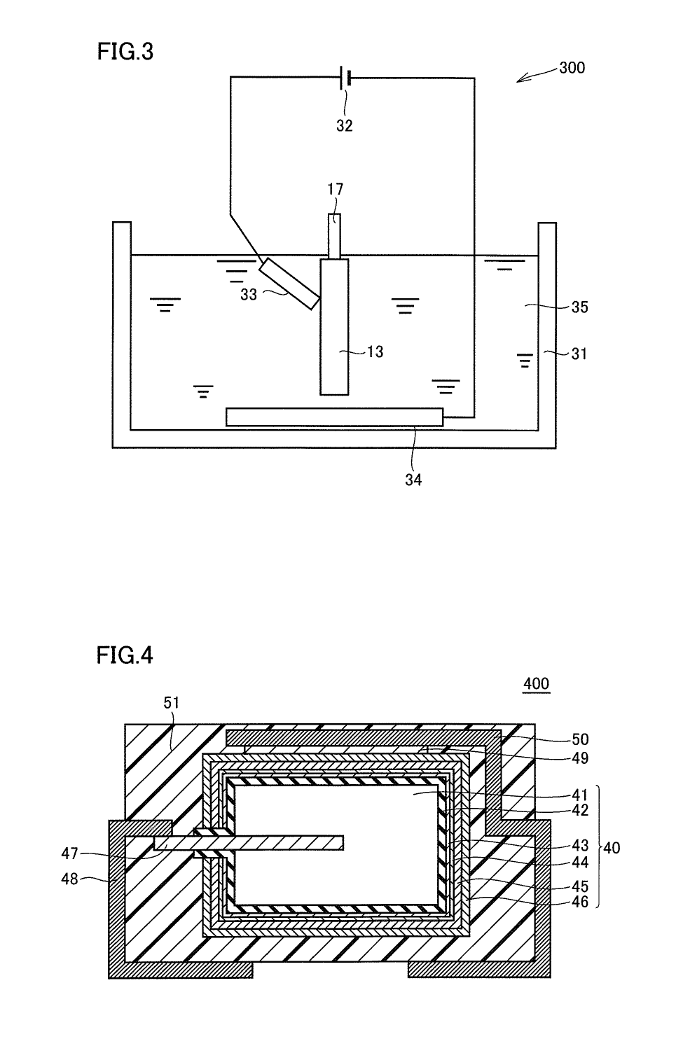

Second conductive polymer layer 14 is preferably formed through electrolytic polymerization. Second conductive polymer layer 14 formed through electrolytic polymerization can have a shape of a film covering the entire surfaces of first conductive polymer layer 13 and dielectric film 12 exposed through opening portions in first conductive polymer layer 13. Therefore, the ion liquid with which anode element 11 is impregnated can be prevented from flowing away to the outside. One exemplary method of forming second conductive polymer layer 14 through electrolytic polymerization will be described hereinafter with reference to FIG. 3.

In FIG. 3, an electrolytic polymerization apparatus 300 includes an electrolyte bath 31 and a DC power supply 32. An anode electrode piece 33 is connected to an anode side of DC power supply 32 and a cathode electrode piece 34 which is a counter electrode of anode electrode piece 33 is connected to a cathode side of DC power supply 32. In addition, a solution containing a monomer for a polymer forming second conductive polymer layer 14 and a dopant can be employed as an electrolyte 35 with which electrolyte bath 31 is to be filled.

In electrolytic polymerization apparatus 300 above, for example, as shown in FIG. 3, anode element 11 having first conductive polymer layer 13 formed is immersed in electrolyte 35. Then, second conductive polymer layer 14 can be formed on first conductive polymer layer 13 by brining anode electrode piece 33 in contact with first conductive polymer layer 13 and feeding power to first conductive polymer layer 13. Though FIG. 3 shows one example of electrolytic polymerization, the method of electrolytic polymerization in the present step is not limited thereto and second conductive polymer layer 14 can be formed with a known technique.

A polymer having at least one of an aliphatic compound, an aromatic compound, a heterocyclic compound, and a heteroatom-containing compound can be employed as the monomer to be contained in electrolyte 35. Among these, thiophene and derivatives thereof, pyrrole and derivatives thereof, aniline and derivatives thereof, and furan and derivatives thereof are preferred, and in particular pyrrole and derivatives thereof can suitably be employed. By using these, second conductive polymer layer 14 having a polythiophene skeleton, a polypyrrole skeleton, a polyaniline skeleton, and a polyfuran skeleton can be formed.

A known dopant can be employed as the dopant, and for example, an acid or a salt of a sulfonic acid compound such as alkyl sulfonic acid, aromatic sulfonic acid, and polycyclic aromatic sulfonic acid, as well as sulfuric acid, nitric acid, and the like can be exemplified. Alternatively, a known oxidizing agent-dopant may be employed as the dopant. It is noted that the monomer and the dopant used in the present step may be the same as the monomer and the dopant that were used in the step of forming first conductive polymer layer 13, or may be different therefrom.

7. Formation of Cathode Layer (Cathode Layer Formation Step)

Then, a cathode layer is formed on second conductive polymer layer 14 in step S106 in FIG. 1. Through the present step, as shown in FIG. 2E, a cathode layer constituted of a carbon layer 15 and a silver paste layer 16 is formed on second conductive polymer layer 14, to thereby fabricate a capacitor element 10. Carbon layer 15 serving as a cathode extraction layer should only have conductivity, and it can be composed, for example, of graphite. It is noted that each of carbon layer 15 and silver paste layer 16 can be formed with a known technique.

8. Sealing of Capacitor Element (Sealing Step)

Finally, in step S107 in FIG. 1, in accordance with a known technique, an anode terminal 18, an adhesive layer 19 and a cathode terminal 20 are arranged in capacitor element 10 and these are sealed with an exterior resin 21 as shown in FIG. 2F. Then, after anode terminal 18 and cathode terminal 20 exposed to the outside through exterior resin 21 are bent along exterior resin 21, they are subjected to aging treatment, to thereby complete a solid electrolytic capacitor 100 shown in FIG. 2F. It is noted that anode terminal 18 and cathode terminal 20 can be made, for example, of a metal such as copper or copper alloy, and for example, epoxy resin can be employed as a material for exterior resin 21.

According to the method of manufacturing a solid electrolytic capacitor in the present embodiment described above in detail, anode element 11 having first conductive polymer layer 13 formed is impregnated with the ion liquid and thereafter the second conductive polymer layer is formed. Since the ion liquid has a function to repair a damaged portion of dielectric film 12, withstand voltage performance of solid electrolytic capacitor 100 can be improved and hence a high-performance solid electrolytic capacitor can be provided.

In addition, by forming first conductive polymer layer 13 through chemical polymerization, first conductive polymer layer 13 present on dielectric film 12 in a distributed manner can be formed. According to this construction, not only first conductive polymer layer 13 can be impregnated with the ion liquid but also the ion liquid can be attached onto exposed dielectric film 12 and additionally it can remain in a gap between distributed first conductive polymer layers 13. Therefore, anode element 11 can hold a large amount of ion liquid and hence frequency of contact and an area of contact between dielectric film 12 and the ion liquid can be increased. Thus, a function to repair dielectric film 12 in solid electrolytic capacitor 100 can reliably be improved. In particular, in a case where first conductive polymer layer 13 is formed through vapor phase polymerization, first conductive polymer layer 13 in a shape distributed on dielectric film 12 can readily be formed.

In addition, by forming second conductive polymer layer 14 through electrolytic polymerization, second conductive polymer layer 14 in a shape of a film covering the entire surfaces of first conductive polymer layer 13 and dielectric film 12 exposed through the opening portions in first conductive polymer layer 13 can readily be formed. Thus, the ion liquid can suitably be prevented from flowing away to the outside.

Moreover, by cleaning anode element 11 before forming second conductive polymer layer 14, the residue in anode element 11 can be removed. Thus, increase in ESR of solid electrolytic capacitor 100 can be suppressed and a higher-performance solid electrolytic capacitor can be provided.

Further, the solid electrolytic capacitor according to the present invention is not limited to the solid electrolytic capacitor according to the embodiment above, and it is applicable to a known shape. For example, a wound-type solid electrolytic capacitor, a stacked-type solid electrolytic capacitor including a plate of a valve metal, and the like are exemplified as the known shape.

In particular, since a sintered object is highly capable of holding an ion liquid, the present invention can more suitably be used in manufacturing a solid electrolytic capacitor having an anode element made of a sintered object.

<Solid Electrolytic Capacitor>

One preferred example of a solid electrolytic capacitor according to the present embodiment will be described hereinafter with reference to FIG. 4. Here, the description will be given referring to a solid electrolytic capacitor having an anode element made of a sintered object.

In FIG. 4, a solid electrolytic capacitor 400 includes a capacitor element 40 having an anode element 41 having a dielectric film 42 formed on a surface thereof, a first conductive polymer layer 43 formed on dielectric film 42, a second conductive polymer layer 44 formed on first conductive polymer layer 43, and a carbon layer 45 and a silver paste layer 46 serving as a cathode extraction layer that are successively formed on second conductive polymer layer 44.

Anode element 41 is made of a sintered valve metal and a rod-shaped anode lead 47 made of a metal is erected thereon. Specifically, arrangement is such that one end of anode lead 47 is buried in anode element 41 and the other end protrudes to the outside of capacitor element 40. Tantalum, niobium, titanium, aluminum, or the like can be used as a valve metal. Anode lead 47 is made of metal, and a valve metal can suitably be used. Carbon layer 45 serving as the cathode extraction layer should only have conductivity, and for example, it can be made of graphite.

Solid electrolytic capacitor 400 further includes an anode terminal 48, an adhesive layer 49, a cathode terminal 50, and an exterior resin 51. Anode terminal 48 is arranged partially in contact with anode lead 47. Meanwhile, cathode terminal 50 is arranged to be connected to silver paste layer 46, which is an outermost layer of capacitor element 40, with adhesive layer 49 made of a conductive adhesive being interposed. Exterior resin 51 seals capacitor element 40 such that a part of anode terminal 48 and a part of cathode terminal 50 are exposed through exterior resin 51.

Anode terminal 48 and cathode terminal 50 should only be made of a metal, and for example, copper can be used therefor. Adhesive layer 49 should only have conductivity and adhesiveness. For example, epoxy resin can be used for exterior resin 51.

In solid electrolytic capacitor 400 above, in the conductive polymer layer constituted of first conductive polymer layer 43 and second conductive polymer layer 44, the ion liquid is present at least in first conductive polymer layer 43. Thus, even when dielectric film 42 is damaged, the ion liquid can repair the damaged portion of dielectric film 42.

In addition, in solid electrolytic capacitor 400, second conductive polymer layer 44 has a structure denser than first conductive polymer layer 43. More preferably, first conductive polymer layer 43 is in a shape distributed on dielectric film 42 and second conductive polymer layer 44 is in a shape of a film covering first conductive polymer layer 43 and dielectric film 42 exposed to the outside through opening portions in first conductive polymer layer 43. This difference in structure can readily be made, for example, by forming first conductive polymer layer 43 through chemical polymerization and forming second conductive polymer layer 44 through electrolytic polymerization.

Since first conductive polymer layer 43 has a relatively coarse structure, first conductive polymer layer 43 can hold a large amount of ion liquid, and in addition, the ion liquid can be present in the vicinity of dielectric film 42. Further, as second conductive polymer layer 44 has a dense structure, the ion liquid in first conductive polymer layer 43 can be prevented from flowing away to the outside.

In particular, in a case where first conductive polymer layer 43 is formed through vapor phase polymerization, first conductive polymer layer 43 present in a distributed manner on dielectric film 42 can be formed in a more simplified manner.

In addition, in the present embodiment, the ion liquid may be present in first conductive polymer layer 43 in a larger amount in a portion located in the vicinity of second conductive polymer layer 44 than in a portion located in the vicinity of dielectric film 42.

First conductive polymer layer 43 and second conductive polymer layer 44 are preferably composed of at least one of polythiophene and derivatives thereof, polypyrrole and derivatives thereof, polyaniline and derivatives thereof, and polyfuran and derivatives thereof. In particular, polypyrrole and derivatives thereof are suitable.

As a cation component forming the ion liquid, for example, ammonium ion and derivatives thereof, imidazolium ion and derivatives thereof, pyrrolidinium ion and derivatives thereof, phosphonium ion and derivatives thereof, sulfonium ion and derivatives thereof, and the like are exemplified. In particular, ammonium ion and derivatives thereof have a large potential window and they are chemically stable, and therefore they are more suitable.

As an anion component, for example, bis(trifluoromethanesulfonyl)imide ion ((CF₃SO₂)₂N⁻), trifluoromethanesulfonic acid ion (CF₃SO₃⁻), trifluoromethanesulfonyl ion (CF₃SO₂⁻), nitrate ion (NO₃⁻), acetic acid ion (CH₃CO₂⁻), tetrafluoroboric acid ion (BF₄⁻), hexafluorophosphoric acid ion (PF₆⁻), trifluoromethanecarboxylate ion (CF₃CO₂⁻), and the like are exemplified. Among these, bis(trifluoromethanesulfonyl)imide ion and trifluoromethanesulfonic acid ion are preferred, and in particular bis(trifluoromethanesulfonyl)imide ion is more suitable.

Among the ion liquids in which the cation component and the anion component above are combined, in particular, any ion liquid of methyltri-n-octylammonium bis(trifluoromethanesulfonyl)imide, 1-butyl-2,3-dimethylimidazolium bis(trifluoromethanesulfonyl)imide, 1-butyl-3-methylimidazolium bis(trifluoromethanesulfonyl)imide, 1-ethyl-2,3-dimethylimidazolium bis(trifluoromethanesulfonyl)imide, 1-butyl-1-methylpyrrolidinium bis(trifluoromethanesulfonyl)imide, 1-methyl-1-propylpyrrolidinium bis(trifluoromethanesulfonyl)imide, cyclohexyltrimethylammonium bis(trifluoromethanesulfonyl)imide, tributyl(2-methoxyethyl)phosphonium bis(trifluoromethanesulfonyl)imide, tributylmethylammonium bis(trifluoromethanesulfonyl)imide, tributylmethylphosphonium bis(trifluoromethanesulfonyl)imide, and triethylsulfonium bis(trifluoromethanesulfonyl)imide is preferably employed. In particular, methyltri-n-octylammonium bis(trifluoromethanesulfonyl)imide expressed in the chemical formula (1) above can suitably be employed.

According to the solid electrolytic capacitor in the present embodiment described above in detail, the ion liquid is present in first conductive polymer layer 43. Therefore, according to the solid electrolytic capacitor in the present embodiment, the ion liquid can repair the damaged portion of dielectric film 42 and hence the solid electrolytic capacitor can have high withstand voltage performance. In addition, the ion liquid may be present in the first conductive polymer layer in a larger amount in a portion located in the vicinity of second conductive polymer layer 44 than in a portion located in the vicinity of dielectric film 42. In this case, first conductive polymer layer 43 can have a larger amount of ion liquid and hence higher withstand voltage performance can be achieved.

The solid electrolytic capacitor according to the present invention is not limited to the solid electrolytic capacitor according to the embodiment above, and it is applicable to a known shape. For example, a wound-type solid electrolytic capacitor, a stacked-type solid electrolytic capacitor including a plate of a valve metal, and the like are exemplified as the known shape.

In particular, since a sintered object is highly capable of holding an ion liquid, the present invention is more suitably applicable to a solid electrolytic capacitor having an anode element made of a sintered object.

### EXAMPLES

The present invention will be described hereinafter in further detail with reference to Examples, however, the present invention is not limited thereto. It is noted that 100 solid electrolytic capacitors were manufactured in each of Examples and Comparative Examples.

### Example 1

Initially, using a known method, tantalum powders were prepared and the tantalum powders were molded in a parallelepiped shape while one end side of a wire-shaped anode lead was buried in the tantalum powders. Then, by sintering the molded powders, the anode element in which one end of the anode lead had been buried was formed. A wire made of tantalum was employed as the anode lead. A dimension of the anode element here was 4.5 mm long×3.5 mm wide×2.5 mm high.

Then, the dielectric film composed of Ta₂O₅ was formed on the surface of the anode element by immersing the anode element in a phosphoric acid solution and applying a voltage of 30 V.

Then, the first conductive polymer layer was formed on the dielectric film through liquid phase polymerization. Specifically, initially, an ethanol solution containing pyrrole at concentration of 3 mol/L and an aqueous solution containing ammonium persulfate and para-toluenesulfonic acid were prepared. Then, the anode element having the dielectric film formed was immersed for 5 minutes in the ethanol solution above adjusted to 25° C., so as to attach pyrrole representing a monomer to the dielectric film. Thereafter, the anode element was taken out of the ethanol solution and successively immersed for 5 minutes in the aqueous solution above set to 25° C. Then, the anode element was taken out of the aqueous solution and dried by being left at room temperature for 10 minutes or longer. Through this operation, the first conductive polymer layer was formed on the dielectric film.

Then, the anode element having the first conductive polymer layer formed was impregnated with the ion liquid. Specifically, initially, methyltri-n-octylammonium bis(trifluoromethanesulfonyl)imide was employed as the ion liquid and an isopropyl alcohol solution containing 10 mass % ion liquid above was prepared. Then, the anode element was immersed for 5 minutes in the isopropyl alcohol solution above, so as to impregnate the anode element with the ion liquid. Thereafter, the anode element was taken out and left at room temperature for 5 minutes or longer, to thereby remove the isopropyl alcohol.

Then, the second conductive polymer layer was formed on the first conductive polymer layer through electrolytic polymerization with the use of electrolytic polymerization apparatus 300 shown in FIG. 3. Specifically, initially, an aqueous solution containing pyrrole and alkylnaphthalenesulfonic acid was prepared as an electrolyte and electrolyte bath 31 of electrolytic polymerization apparatus 300 was filled with the aqueous solution. Then, the first conductive polymer layer and anode electrode piece 33 were brought in contact with each other and a current at 0.5 mA was fed to the first conductive polymer layer for 3 hours. Through this operation, the second conductive polymer layer was formed on the first conductive polymer layer.

After the operation above ended, the anode element was taken out of the electrolyte, washed with water, and thereafter arranged in a drier at 100° C. for drying for 10 minutes. Then, the carbon layer was formed by applying a graphite particle suspension to the dried anode element and drying the same in atmosphere, and further the silver paste layer was formed in accordance with a known technique, to thereby fabricate the capacitor element.

Then, in the capacitor element, the anode terminal made of copper was welded to the anode lead, the silver adhesive was applied to the silver paste layer to form an adhesive layer, and one end of the cathode terminal made of copper was bonded to the adhesive layer. Further, the capacitor element was sealed with the exterior resin such that a part of the anode terminal and the cathode terminal was exposed. After the exposed anode terminal and cathode terminal were bent along the exterior resin, they were subjected to aging treatment.

As described above, the solid electrolytic capacitor was completed through the anode element formation step, the first conductive polymer layer formation step by liquid phase polymerization, the ion liquid impregnation step, the second conductive polymer layer formation step by electrolytic polymerization, the cathode layer formation step, and the sealing step. The manufactured solid electrolytic capacitor had a rated voltage of 10 V and a rated capacitance of 330 μF, and it was 7.3 mm long×4.3 mm wide×3.8 mm high.

### Example 2

The solid electrolytic capacitor was manufactured with the method the same as in Example 1 except that the cleaning step was provided to clean the anode element after formation of the first conductive polymer layer and before impregnation thereof with the ion liquid. Namely, the solid electrolytic capacitor was completed through the anode element formation step, the first conductive polymer layer formation step by liquid phase polymerization, the cleaning step, the ion liquid impregnation step, the second conductive polymer layer formation step by electrolytic polymerization, the cathode layer formation step, and the sealing step.

As a specific operation in the cleaning step, an operation to immerse the anode element in pure water for 10 minutes and then taking out the anode element was performed once and thereafter the anode element was arranged in the drier at 100° C. for drying for 10 minutes.

### Example 3

The solid electrolytic capacitor was manufactured with the method the same as in Example 1 except for forming the first conductive polymer layer through vapor phase polymerization. Namely, the solid electrolytic capacitor was completed through the anode element formation step, the first conductive polymer layer formation step by vapor phase polymerization, the ion liquid impregnation step, the second conductive polymer layer formation step by electrolytic polymerization, the cathode layer formation step, and the sealing step.

As a specific operation in vapor phase polymerization, initially, the anode element having the dielectric film formed was immersed for 5 minutes in an aqueous solution at 25° C. containing hydrogen peroxide and sulfuric acid. Then, after the anode element was taken out of the aqueous solution, the anode element was exposed to a pyrrole gas. Thus, the first conductive polymer layer was formed on the dielectric film.

### Example 4

The solid electrolytic capacitor was manufactured with the method the same as in Example 3 except that the cleaning step the same as in Example 2 was provided after formation of the first conductive polymer layer and before impregnation thereof with the ion liquid. Namely, the solid electrolytic capacitor was completed through the anode element formation step, the first conductive polymer layer formation step by vapor phase polymerization, the cleaning step, the ion liquid impregnation step, the second conductive polymer layer formation step by electrolytic polymerization, the cathode layer formation step, and the sealing step.

### Comparative Example 1

The operation the same as in Example 4 was performed except for not performing the operation for impregnation with the ion liquid. Namely, the solid electrolytic capacitor was completed through the anode element formation step, the first conductive polymer layer formation step by vapor phase polymerization, the cleaning step, the second conductive polymer layer formation step by electrolytic polymerization, the cathode layer formation step, and the sealing step.

### Comparative Example 2

The solid electrolytic capacitor was manufactured with the method the same as in Example 1 except that the operation for impregnating the first conductive polymer layer with the ion liquid was not performed but the anode element having the dielectric film formed was immersed for 5 minutes in an isopropyl alcohol solution containing 10 mass % methyltri-n-octylammonium bis(trifluoromethanesulfonyl)imide, and thereafter the first conductive polymer layer was formed. Namely, the solid electrolytic capacitor was completed by performing the anode element formation step and thereafter impregnating the anode element with the ion liquid, followed by the first conductive polymer layer formation step by liquid phase polymerization, the second conductive polymer layer formation step by electrolytic polymerization, the cathode layer formation step, and the sealing step.

### Comparative Example 3

The solid electrolytic capacitor was manufactured with the method the same as in Comparative Example 2 except that, after the first conductive polymer layer was formed, an operation for immersing the anode element for 10 minutes in pure water and then taking out the anode element was once performed, and thereafter the anode element was arranged in the drier at 100° C. for drying for 10 minutes. Namely, the solid electrolytic capacitor was completed by performing the anode element formation step and thereafter impregnating the anode element with the ion liquid, followed by the first conductive polymer layer formation step by liquid phase polymerization, the cleaning step, the second conductive polymer layer formation step by electrolytic polymerization, the cathode layer formation step, and the sealing step.

<Performance Evaluation>

<<Measurement of ESR>>

From the solid electrolytic capacitors according to each of Examples 1 to 4 and each of Comparative Examples 1 to 3, 20 solid electrolytic capacitors were randomly extracted. ESR (mΩ) at a frequency of 100 kHz, of each solid electrolytic capacitor in each of Examples 1 to 4 and each of Comparative Examples 1 to 3 was measured by using an LCR meter for 4-terminal measurement, and an average value in each of Examples 1 to 4 and each of Comparative Examples 1 to 3 was calculated. The results are shown in “ESR (mΩ)” in Table 1.

<<Withstand Voltage Test>>

From the solid electrolytic capacitors according to each of Examples 1 to 4 and each of Comparative Examples 1 to 3, 20 solid electrolytic capacitors were randomly extracted. The solid electrolytic capacitor according to each of Examples 1 to 4 and each of Comparative Examples 1 to 3 was subjected to a withstand voltage test, with an applied DC voltage being increased at a rate of 1 V/sec. A voltage at which a leakage current attained to 1 mA or higher was determined as the withstand voltage, and an average value in the solid electrolytic capacitor according to each of Examples 1 to 4 and each of Comparative Examples 1 to 3 was calculated. The results are shown in “Withstand Voltage (V)” in Table 1.

<<Surge Withstand Voltage Test>>

From the solid electrolytic capacitors according to each of Examples 1 to 4 and each of Comparative Examples 1 to 3, 20 solid electrolytic capacitors were randomly extracted. The solid electrolytic capacitor according to each of Examples 1 to 4 and each of Comparative Examples 1 to 3 was subjected to a surge withstand voltage test in an environment at 105° C. representing a highest operating temperature. Specifically, a 1-kΩ discharge resistor was connected to each solid electrolytic capacitor, and then a cycle lasting 6 minutes in total, in which discharge was carried out for 5 minutes and 30 seconds and charging was carried out for 30 seconds, was repeated 1000 times for the solid electrolytic capacitor. After this test ended, a leakage current in each solid electrolytic capacitor was measured. When the leakage current attained to 1 mA or higher, determination as failure was made, and the number of failures was counted. The results are shown in “Failure Count (Pieces)” in Table 1.

TABLE 1

| | | Withstand | |
|---|---|---|---|
| | ESR | Voltage | Failure Count |
| | (mΩ) | (V) | (Pieces) |
| Example 1 | 56 | 23.6 | 0 |
| Example 2 | 22 | 24.1 | 0 |
| Example 3 | 48 | 23.2 | 0 |
| Example 4 | 20 | 24.3 | 0 |
| Comparative | 19 | 20.5 | 4 |
| Example 1 | | | |
| Comparative | 55 | 21.4 | 3 |
| Example 2 | | | |
| Comparative | 22 | 20.8 | 4 |
| Example 3 | | | |

Referring to Table 1, Example 1 was higher in withstand voltage than Comparative Example 1. In addition, 4 of the 20 solid electrolytic capacitors according to Comparative Example 1 failed after the surge withstand voltage test, whereas no solid electrolytic capacitor according to Example 1 failed. Based on this result, it was found that withstand voltage performance of the solid electrolytic capacitor could be enhanced by impregnating the anode element with the ion liquid.

Based on comparison between Example 1 and Example 2, it was found that ESR was lower in the example where the ion liquid impregnation step was performed after the cleaning step. It is considered that, by cleaning the anode element, such residues as an unnecessary oxide and an unreacted monomer could be removed and consequently ESR could be lowered.

In addition, the example where the ion liquid impregnation step was performed after the cleaning step was higher in withstand voltage. The reason may be because impurities present in the opening portions in the first conductive polymer layer or on the dielectric film exposed through the opening portions were removed in the cleaning step to thereby reproduce a space and because an amount of the ion liquid that can be present in the capacitor element, such as on the dielectric film, increased in the first conductive polymer layer.

In Example 1, the first conductive polymer layer was formed through liquid phase polymerization, however, it was found that the example where the first conductive polymer layer was formed through vapor phase polymerization such as Example 3 also achieved withstand voltage performance higher than the case of Comparative Example 1. In addition, based on comparison between Example 3 and Example 4, it was found that ESR could be lowered and a withstand voltage could be raised by providing the cleaning step, as in the case of Examples 1 and 2. Each reason therefor is considered as similar to those above.

Here, based on comparison between an effect of the clearing step in the example where the first conductive polymer layer was formed through liquid phase polymerization (Example 1 and Example 2) and an effect of the clearing step in the example where the first conductive polymer layer was formed through vapor phase polymerization (Example 3 and Example 4), it can be seen that a rate of improvement in withstand voltage performance through the cleaning step is higher in the latter examples.

This is because there are voids in the structure of the first conductive polymer layer formed through vapor phase polymerization more than in the structure of the first conductive polymer layer formed through liquid phase polymerization. Namely, it is considered that, though impurities on the anode element can be removed through the cleaning step, the number and the size of spaces reproduced as a result of removal of these impurities are larger in the first conductive polymer layer formed through vapor phase polymerization. Therefore, it is considered that variation in an area of openings in the first conductive polymer layer depending on presence/absence of the cleaning step is greater in vapor phase polymerization, and consequently a withstand voltage more significantly improved by performing the cleaning step.

Meanwhile, according to Comparative Example 2, even when the first conductive polymer layer was formed after the anode element having the dielectric film formed was immersed in the ion liquid, improvement in withstand voltage performance as in Example 1 was not observed. This may be because, even though the ion liquid was attached onto the dielectric film by immersing the dielectric film in the ion liquid, the attached ion liquid was removed through the operation for impregnation with a solution containing a monomer and a solution containing an oxidizing agent.

Turning to Comparative Example 3, it was found that a withstand voltage was further lower than in the case of Comparative Example 2, as a result of cleaning of the anode element. This may be because the ion liquid flowed away to the outside through cleaning of the anode element. Therefore, it is considered that, even though the conductive polymer layer was formed with the use of a solution containing the ion liquid, the monomer and the oxidizing agent, for example as in Japanese Patent Laying-Open Nos. 2006-24708, 2008-16835 and 2008-218920, the ion liquid in the conductive polymer layer flowed away when the step of cleaning the conductive polymer layer was subsequently provided. In contrast, since the cleaning step can be performed before the ion liquid impregnation step in Example 2 and Example 4, the problem as above does not arise and hence a function of the ion liquid to repair the dielectric film can reliably be ensured.

Based on comparison among Examples 1 to 4 and Comparative Examples 1 to 3 above, it was found that an effect of the ion liquid can be exhibited most in the case shown in Example 4 where impregnation with the ion liquid was performed after the first conductive polymer layer was formed through vapor phase polymerization and washed with water. Then, studies on variation in concentration of an ion liquid to be used in the manufacturing method according to Example 4 were conducted.

### Example 5

The solid electrolytic capacitor was manufactured with the method the same as in Example 4 except for preparing an isopropyl alcohol solution containing 20 mass % methyltri-n-octylammonium bis(trifluoromethanesulfonyl)imide as a solution containing the ion liquid.

### Example 6

The solid electrolytic capacitor was manufactured with the method the same as in Example 4 except for preparing an isopropyl alcohol solution containing 50 mass methyltri-n-octylammonium bis(trifluoromethanesulfonyl)imide as a solution containing the ion liquid.

### Example 7

The solid electrolytic capacitor was manufactured with the method the same as in Example 4 except for using 100 mass % ion liquid, that is, the ion liquid as it is, without dilution with methyltri-n-octylammonium bis(trifluoromethanesulfonyl)imide isopropyl alcohol.

### Comparative Example 4

The solid electrolytic capacitor was manufactured with the method the same as in Example 4 except for preparing an isopropyl alcohol solution containing 5 mass methyltri-n-octylammonium bis(trifluoromethanesulfonyl)imide as a solution containing the ion liquid.

Twenty solid electrolytic capacitors in each of Examples 5 to 7 and Comparative Example 4 were used for the withstand voltage test and the surge voltage test described above. Table 2 shows the results. In addition, Table 2 also shows the results in Example 4 and Comparative Example 1.

TABLE 2

| | Ion Liquid | Withstand | |
|---|---|---|---|
| | Concentration | Voltage | Failure Count |
| | (Mass %) | (V) | (Pieces) |
| Example 4 | 10 | 24.3 | 0 |
| Example 5 | 20 | 26 | 0 |
| Example 6 | 50 | 26.7 | 0 |
| Example 7 | 100 | 28 | 0 |
| Comparative | 0 | 20.5 | 4 |
| Example 1 | | | |
| Comparative | 5 | 23.5 | 1 |
| Example 4 | | | |

Referring to Table 2, it was found that the withstand voltage performance of the solid electrolytic capacitor was higher as concentration (mass %) of the ion liquid in the solution for impregnating the anode element was higher. In addition, it was found that occurrence of failure after the surge voltage test was not observed when concentration of the ion liquid was not lower than 10 mass %.

Although the present invention has been described and illustrated in detail, it is 9 clearly understood that the same is by way of illustration and example only and is not to be taken by way of limitation, the scope of the present invention being interpreted by the terms of the appended claims.

What is claimed is:

1. A method of manufacturing a solid electrolytic capacitor, comprising the steps of:
forming a dielectric film on a surface of an anode element;
forming a first conductive polymer layer on said dielectric film;
impregnating said anode element having said first conductive polymer layer formed with an ion liquid; and
forming a second conductive polymer layer on said first conductive polymer layer after impregnation with said ion liquid.

2. The method of manufacturing a solid electrolytic capacitor according to claim 1, wherein
said second conductive polymer layer is formed through electrolytic polymerization.

3. The method of manufacturing a solid electrolytic capacitor according to claim 1, wherein
said first conductive polymer layer is formed through chemical polymerization.

4. The method of manufacturing a solid electrolytic capacitor according to claim 1, comprising the step of cleaning said anode element having said first conductive polymer layer formed before the step of impregnating said anode element with an ion liquid.

5. The method of manufacturing a solid electrolytic capacitor according to claim 3, wherein
said chemical polymerization is vapor phase polymerization.

6. The method of manufacturing a solid electrolytic capacitor according to claim 1, wherein
said anode element having said first conductive polymer layer formed is impregnated with said ion liquid by using a solution prepared such that a content of said ion liquid is not lower than 10 weight %.

7. A solid electrolytic capacitor, comprising a capacitor element which has an anode element having a dielectric film formed on a surface thereof and a conductive polymer layer formed on said anode element,
said conductive polymer layer having a first conductive polymer layer formed on said dielectric film and a second conductive polymer layer formed on said first conductive polymer layer,
an ion liquid being present in said first conductive polymer layer, and
said second conductive polymer layer having a structure denser than said first conductive polymer layer.

8. The solid electrolytic capacitor according to claim 7, wherein
said ion liquid is present in said first conductive polymer layer in a larger amount around said second conductive polymer layer, than around said dielectric film.

9. The solid electrolytic capacitor according to claim 7, wherein
said first conductive polymer layer is constituted of a plurality of conductive polymer portions present in a distributed manner on said dielectric film.
